(19) United States
(12) Patent Application Publication
(10) Pub. No.: US 2004/0204046 A1
(43) Pub. Date: Oct. 14, 2004

(54) Piconet congestion relief method for mobile AD hoc networks

(75) Inventors: Jeffrey D. Bonta, Arlington Heights, IL (US); Ye Chen, Schaumburg, IL (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 10/159,664

(22) Filed: May 31, 2002

(51) Int. Cl. H04M 1/00

(52) U.S. Cl. 455/556.1; 455/553.1

(57) ABSTRACT

A method of dividing a first piconet into two or more piconets is implemented by a master wireless device. The master wireless device selects a master for a second piconet from among the slave wireless devices within the first piconet. The selection can be based upon each operational link between a base site and candidates for master of the second piconet as well as each operational link between the candidates for master of the second piconet and candidates for active slaves of the second piconet. The master wireless device thereafter informs each slave of the first piconet of the selection of the master of the second piconet. The master wireless device can further assign one or more of the slaves of the first piconet to enlist as a slave in the second piconet, or alternatively, each slave of the first piconet can enlist as a slave in either the first piconet or the second piconet.

### FIELD OF THE INVENTION

The present invention generally relates to methods for establishing a mobile ad hoc network. More specifically, the present invention relates to an establishment of a mobile ad hoc network that dynamically divides an existing piconet into two or more piconets.

### BACKGROUND OF THE INVENTION

Ad hoc networking is a technology that enables wireless devices to form a cooperative communication network. Currently, there are various known air interfaces that support ad hoc networking, such as, for example, 802.11 and Bluetooth. Other well known fixed wireless networks (e.g., cellular) communicate through a point-to-multipoint configuration and depend on wide area coverage to deliver service to the end user. However, this type of configuration is not always capable of providing an adequate signal to the entire coverage area due to physical obstructions such as buildings that impede the signal. FIG. 1 illustrates an application of ad hoc networking that utilizes a known air interface to extend coverage for cellular systems, thus forming a hybrid communications network using ad hoc networking and cellular networking.

Cellular handsets CH1-CH12 are dual mode handsets capable of interoperating between a known cellular air interface, such as WCDMA, and a known ad hoc networking air interface, such as Bluetooth. Thus, these cellular capable handsets CH1-CH12 are capable of forming a local ad hoc network by utilizing the Bluetooth device contained within the cellular handset. As a Bluetooth device, this local ad hoc network is referred to as a piconet. A Bluetooth piconet consists of a master device and some number of slave devices. A Bluetooth piconet typically has up to 7 active slaves that share a channel with the master. In addition, many more slaves can remain synchronized with the master in a parked state, but do not share the same channel. These parked slaves have less frequent communication with the master than the active slaves have with the master. When the Bluetooth device within a cellular handset CH1-CH12 is the master of a piconet, then the cellular handset is a master cellular handset of the piconet. Likewise, when the Bluetooth device within a cellular handset CH1-CH12 is a slave, then the cellular handset is either an active slave cellular handset or a parked slave cellular handset depending on its state within the piconet.

Cellular handsets CH1-CH7 are shown within a coverage hole 12 of a cellular wide area network (“WAN”) 10 having a cell site 11. The coverage hole 12 impedes cellular handsets CH1-CH7 from receiving an adequate cellular signal from the cell site 11. Cellular handsets CH8-CH12 have adequate coverage with the cell site 11, and the cellular handsets CH1-CH7 therefore attempt to utilize the Bluetooth air interface to establish and maintain a voice call and/or a data call with one of the cellular handsets CH8-CH12 that is designated as the master. Another application of ad hoc networking is to utilize a dual mode cellular/air interface capability of the master to extend the capacity of the remaining cellular handsets among the cellular handsets CH8-CH12. In either application, the master relays signaling and traffic data from each slave over the master's communication links to the cell site 11.

The cellular handsets CH1-CH12 form an exemplary piconet 13 having a master and slave cellular handsets being served by the master. An ad hoc network technology, such as Bluetooth, can only support a maximum number of active slaves. More specifically, Bluetooth currently can support a maximum of seven (7) active slaves with a maximum of three (3) active slaves being a more practical limit in view of a minimum system data rate threshold (e.g., 144 kbit/sec). Thus, piconet 13 would be formed having three (3) active slaves and nine (9) parked slaves whereby any parked slaves in the coverage hole 12 do not benefit from the master in terms of gaining coverage that otherwise would not be attainable and any parked slaves outside the coverage hole 12 do not benefit from a utilization of the throughput of the master. The present invention advances the art by providing a method of dynamically dividing piconet 13 into two or more piconets in a manner facilitating an optimal utilization of coverage and/or throughput among the cellular handsets CH1-CH12.

### SUMMARY OF THE INVENTION

One form of the present invention is a first method of operating a master wireless device of a first piconet in forming a second piconet. First, the master wireless device identifies one or more master candidates among a plurality of slave wireless devices within the first piconet. Second, the master wireless device selects a master of the second piconet from among the master candidate(s).

A second form of the present invention is a second method of operating a master wireless device of a first piconet in forming a second piconet. First, the master wireless device receives a first operational data indicative of an operational link between a base site and a first set of two or more slave wireless devices within the first piconet. Second, the master wireless device receives a second operational data representative of an operational link between the first set of two or more slave wireless devices and a second set of one or more slave wireless devices. Third, the master wireless device selects a master of the second piconet from among the first set of two or more slave wireless devices based upon the first operational data and the second operational data.

A third form of the present invention is a third method of operating a master wireless device of a first piconet in forming a second piconet. First, the master wireless device selects a master of the second piconet from among a plurality of slave wireless devices within the first piconet. Second, the master wireless device assigns a subset of slave wireless devices within the first piconet to enlist in the second piconet.

A fourth form of the present invention is a fourth method of operating a master wireless device of a first piconet in forming a second piconet. First, the master wireless device selects a first master of the second piconet from among a plurality of slave wireless devices within the first piconet. Second, the master wireless device selects a second master of the second piconet from among the plurality of slave wireless devices within the first piconet in response to a communication from the first master indicative of a failure of the first master to enlist any slave wireless devices to the second piconet.

The foregoing forms and other forms as well as features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 illustrates an exemplary piconet as known in the art;

FIG. 2 illustrates exemplary designations of masters and slaves within the FIG. 1 piconet;

FIG. 3 illustrates a pair of flowcharts representative of a piconet division method in accordance with one embodiment of the present invention;

FIG. 4 illustrates a flowchart representative of a viable master determination method in accordance with one embodiment of the present invention; and

FIG. 5 illustrates three (3) exemplary piconets resulting from a division of the FIG. 1 piconet in accordance with the FIG. 3 flowcharts.

### DETAILED DESCRIPTION OF THE PRESENTLY PREFERRED EMBODIMENTS

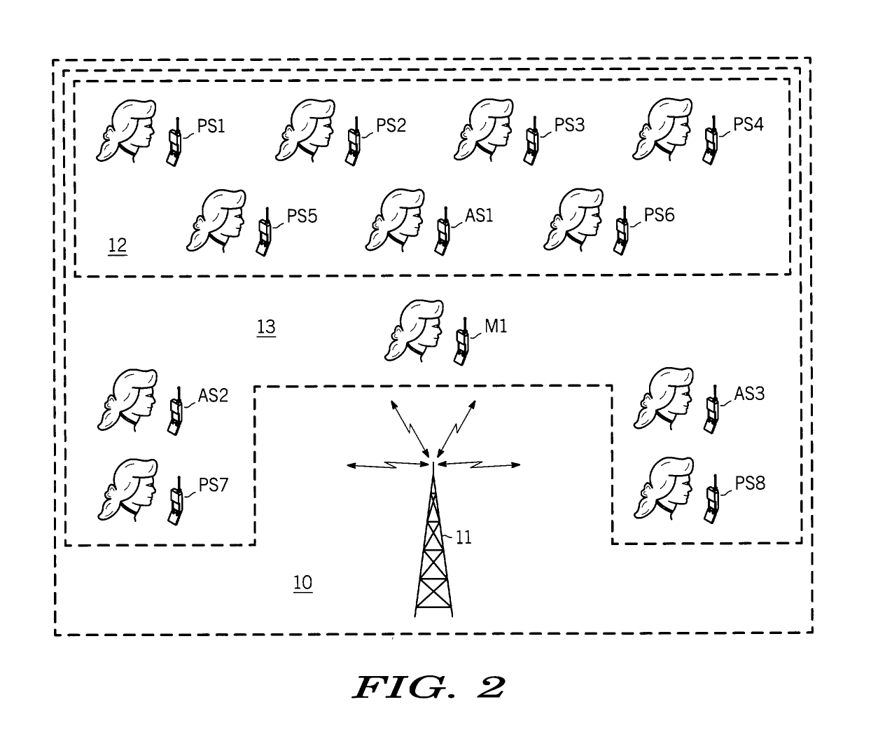

FIG. 2 illustrates an exemplary designation within the piconet 13 of a master M1 three (3) active slaves AS1-AS3, and eight (8) parked slaves PS1-PS8. This exemplary designation is to facilitate a description of a division of the piconet 13 into three piconets in accordance with the present invention.

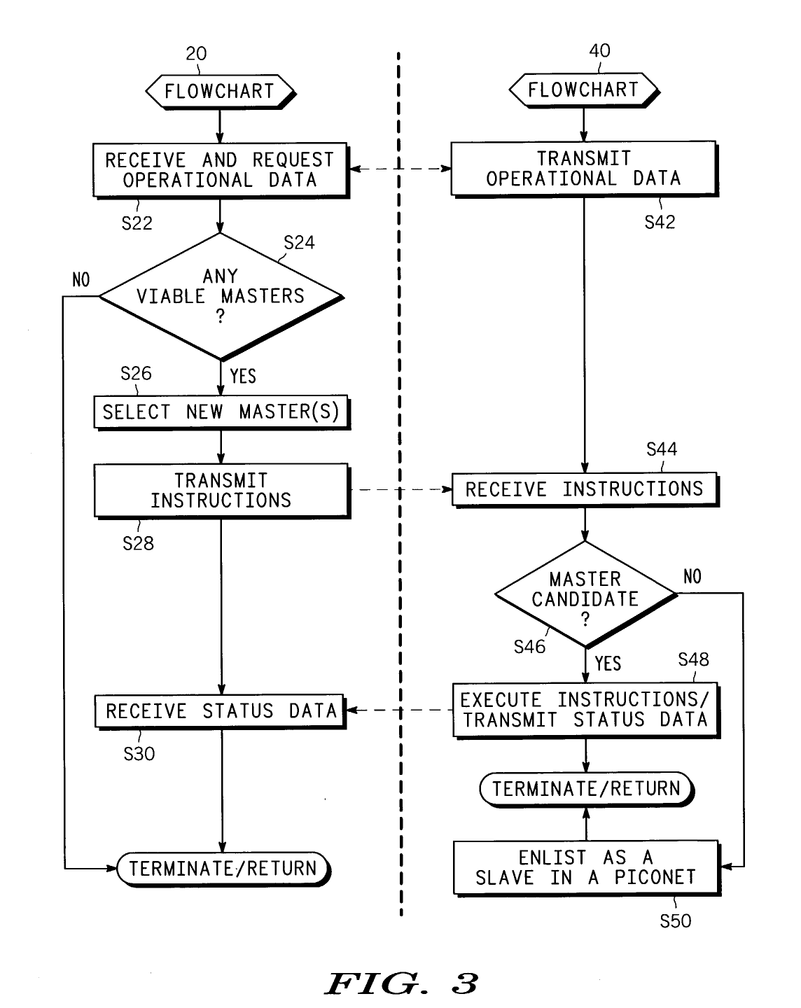

FIG. 3 illustrates a flowchart 20 and a flowchart 40 collectively representative of a piconet division method of the present invention. An implementation of the flowchart 20 and the flowchart 40 facilitates a creation of multiple communication links from the cell site 11 to multiple masters having one or more active slaves whereby an optimal utilization of coverage and/or throughput within the network 10 can be realized.

During a stage S22 of the flowchart 20, the master M1 requests and receives operational data related to the slaves as transmitted from the active slaves AS1-AS3 and the parked slaves PS1-PS8 during a stage S42 of the flowchart 40. In one embodiment, the operational data from the active slaves AS1-AS3 includes information related to a signal-to-noise ratio (“S/N”) and/or quality of each cellular link between the cell site 11 (FIG. 2) and each active slaves AS1-AS3 while the operational data from the parked slaves PS1-PS8 includes information related to a S/N or a Received Signal Strength indication (RSSI) of each Bluetooth link between the parked slaves PS1-PS8 and the active slaves AS1-AS3. In a second embodiment, the operational data from the parked slaves PS1-PS8 also includes information related to a signal-to-noise ratio (“S/N”) and/or quality of each cellular link between the cell site 11 and the parked slaves PS1-PS8 as well as cellular connection information. In the operational data request or upon a request from a slave, the master M1 can include information to facilitate the development of the operational data by the slaves, such as, for example, a transmission time between each slave and it's master to enable one slave to measure another slave's S/N or RSSI.

During a stage S24 of the flowchart 20, the master M1 determines if there are any viable masters among the active slaves AS1-AS3 and the parked slaves PS1-PS8. In one embodiment, the master M1 implements a viable master determination routine during the stage S24.

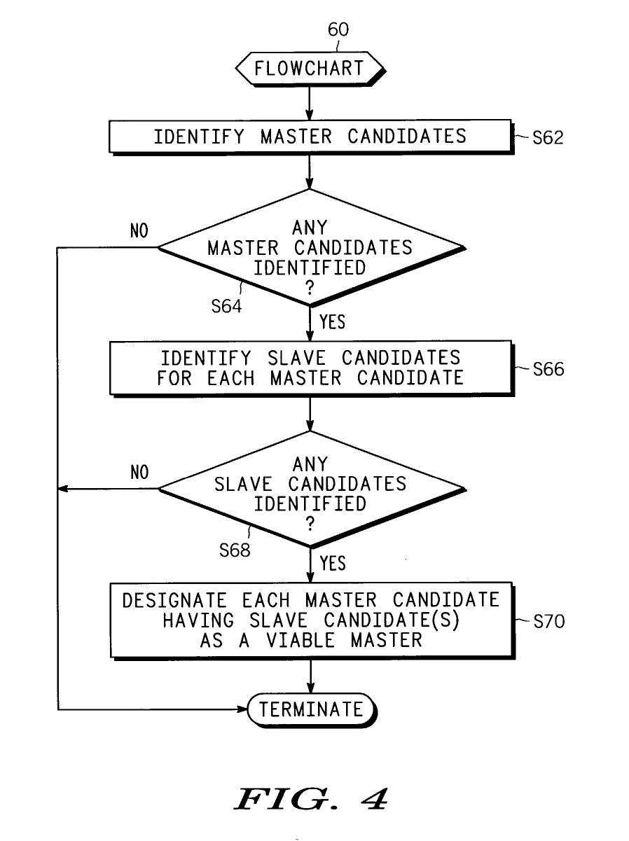

FIG. 4 illustrates a flowchart 60 representative of a viable master determination method of the present invention. During a stage S62 of the flowchart 60, the master M1 determines which slaves of the piconet 13 (FIG. 2) are candidates to be masters. In one embodiment, the master M1 analyzes the operational data related to a S/N and/or quality of each cellular link between the cell site 11 and the active slaves AS1-AS3 to identify master candidates among the active slaves AS1-AS3. A master candidate is defined as a cellular handset having adequate coverage with the cell site 11 to support a piconet within specified bounds (e.g., maximum number of slaves, minimum data rate threshold, etc.). The following TABLE 1 lists an exemplary identification of master candidates among the active slaves AS1-AS3:

TABLE 1

| MASTER CANDIDATES | DISQUALIFIED CANDIDATES |
|---|---|
| AS2 | AS1 |
| AS3 | |

In a second embodiment, the master M1 concurrently or alternatively analyzes the operational data related to a S/N and/or quality of each cellular link between the cell site 11 and the parked slaves PS1-PS8 to identify master candidates among the parked slaves PS1-PS8. The following TABLE 2 lists an exemplary identification of master candidates among the active slaves AS1-AS3 and the parked slaves PS1-PS8:

TABLE 2

| MASTER CANDIDATES | DISQUALIFIED CANDIDATES |
|---|---|
| AS2 | AS1 |
| AS3 | PS1-PS6 |
| PS7 | |
| PS8 | |

The master M1 terminates the flowchart 60 upon a failure by the master M1 to identify master candidates during the stage S62. Otherwise, during a stage S66 of the flowchart 60, the master M1 identifies slave candidates for each master candidate. In one embodiment, the master M1 analyzes the operational data related to a S/N or RSSI of each Bluetooth link between the parked slaves PS1-PS8 and the active slaves AS2 and AS3. The following TABLE 3 lists an exemplary identification of slave candidates for the master candidates of TABLE 1:

TABLE 3

| MASTER CANDIDATE | SLAVE CANDIDATES |
|---|---|
| AS2 | PS1-PS3 |
| | PS5 |
| | PS7 |
| | PS8 |
| AS3 | PS3 |
| | PS4 |
| | PS6 |

Please note that a slave can be identified as a slave candidate for multiple master candidates (e.g., parked slave PS3 in TABLE 3).

The master M1 terminates the flowchart 60 upon a failure by the master M1 to identify slave candidates for at least one master candidate. Otherwise, during a stage S70 of the flowchart 60, the master M1 designates each master candidate having at least one slave candidate as a viable master. For example, the master M1 would designate active slave AS2 and AS3 as viable masters in accordance with TABLE 3.

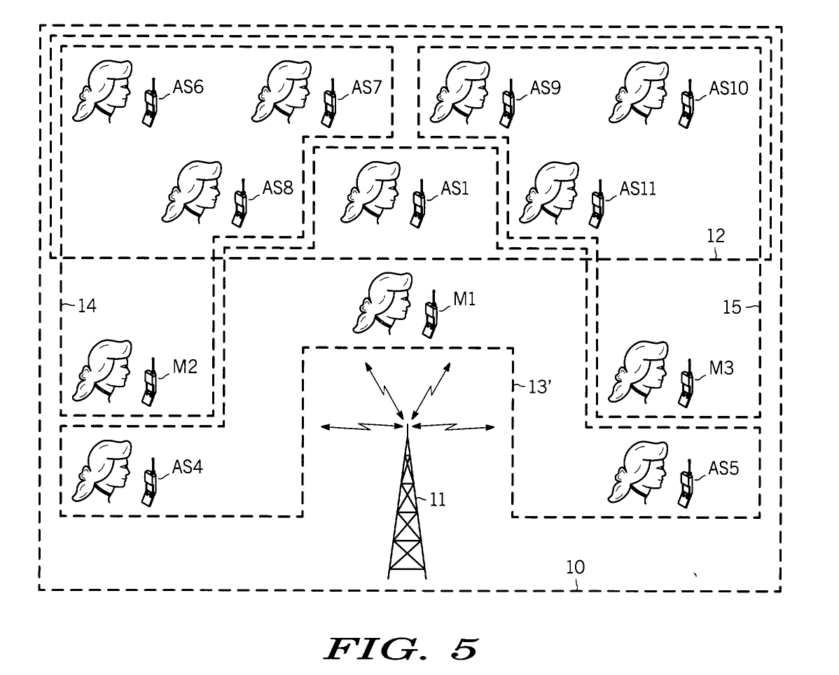

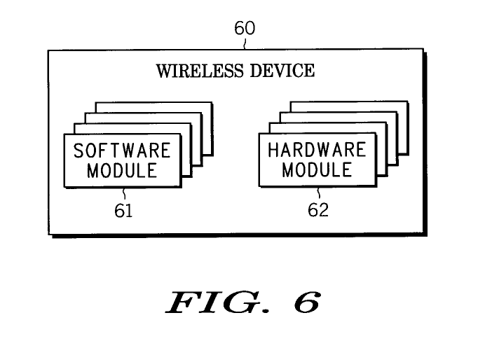

Referring again to FIG. 3, during a stage S26 of the flowchart 20, the master M1 selects one or more new masters to form new piconets. In one embodiment, the master M1 selects each master candidate to be a master of one of the new piconets. For example, the master M1 could select the active slave AS2 to be a master M2 of a piconet 14 illustrated in FIG. 5 and select the active slave AS3 to be a master M3 of a piconet 15 illustrated in FIG. 5.

During a stage S28 of the flowchart 20, the master M1 transmits instructions related to a formation of new piconets and associated masters thereof to the active slaves AS1-AS3 and the parked slaves PS1-PS8. The instructions can include information necessary for each new master to form a piconet, such as for example, information to synchronize with parked or active slaves as well as information to enable existing cellular connections to be maintained. The instructions can further include an order for the new masters to broadcast an invitation message to potential slave candidates to enlist with the associated piconet.

In one embodiment, the instructions further include a partial or complete assignment of slaves for a revised version of the original piconet as well as a partial or complete designation of slaves for the new piconets. For example, the master M1 can assign active slave AS1 and parked slaves PS7 and PS8 to become active slaves AS1, AS4 and AS5, respectively, of the piconet 13′(i.e., a revised version of piconet 13) as illustrated in FIG. 5. The master M1 can further assign the parked slaves PS1, PS2 and PS5 to become active slaves AS6-AS8, respectively, of the piconet 14 as illustrated in FIG. 5, and assign the parked slaves PS3, PS4 and PS6 to become slaves active slaves AS9-AS11, respectively, of the piconet 15 as illustrated in FIG. 5.

In response to the instructions, each slave determines whether they are a master candidate during a stage S46 of the flowchart 40. Each slave deemed a master candidate would proceed to a stage S48 of the flowchart 40 to execute the appropriate instructions from the master M1 and, after a predefined delay, to transmit status data related to a complete or incomplete formation of the associated piconet. Each slave deemed a slave candidate would proceed to a stage S50 of the flowchart 40 to enlist within a piconet, by assignment or invitation, prior to an expiration of the predefined delay. Referring to FIGS. 3 and 5, an indication within the status data of complete formations of all piconets 13′-15 initiates a termination of the flowchart 20 by the master M1 and a termination of the flowchart 40 by the masters M2 and M3 as well as the active slaves AS1, and AS4-AS9. Any indication within the status data of an incomplete formation of one or more piconets 13′-15 may trigger a subsequent implementation of the flowchart 20 by one of the masters M1-M3 and the flowchart 40 by the others masters and slaves.

From the description of various flowcharts illustrated in FIGS. 3 and 4, those having ordinary skill in the art will appreciate various benefits of the present invention. One of the benefits is an elimination of congestion within a piconet that facilitates an optimal formation of two or more piconets from the original piconet.

While the present invention was described in the context of cellular handsets within a piconet, the present invention can be implemented in an employment of other types of wireless devices within a piconet having ad hoc networking technology, such as, for example, a Personal Data Assistant.

FIG. 6 illustrates a wireless device 60. In addition to conventional ad hoc networking technology (e.g., Bluetooth), the wireless device 60 employing the present invention (e.g., the cellular handsets illustrated in FIG. 2) further includes one or more software modules 61, one or more hardware modules 62, and/or a combination thereof with each module being designed as would be appreciated by those having ordinary skill in the art to implement one or more stages of the illustrated flowcharts of FIGS. 3-7 or alternative embodiments thereof within the spirit of the present invention.

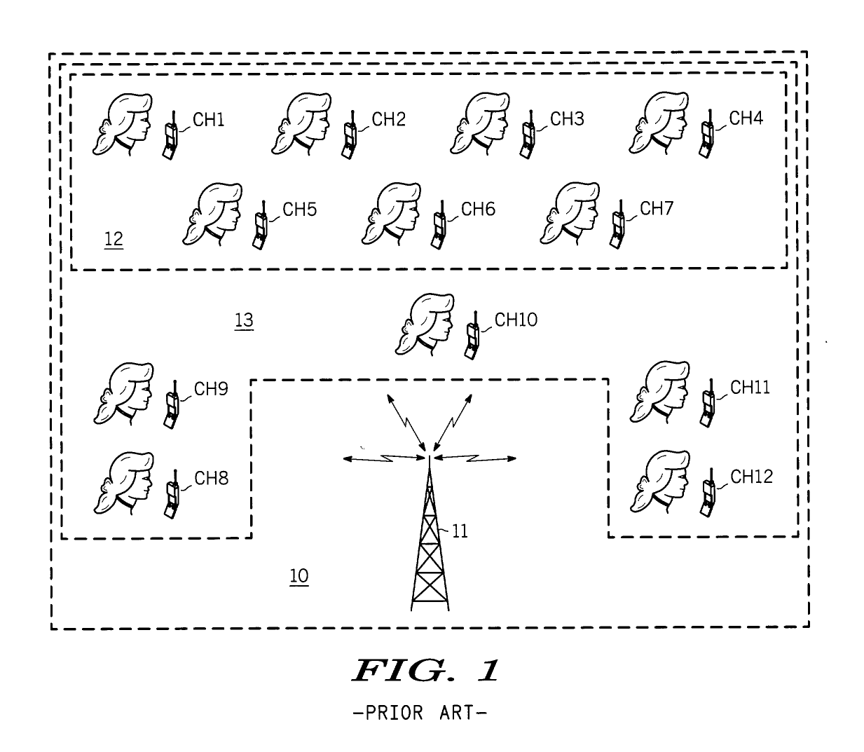

The piconets 13-15 (FIGS. 1, 2 and 4) were illustrated for purposes of describing various methods of the present invention. The number of piconet configurations employing the present invention is essentially limitless as will be appreciated by those having ordinary skill in the art.

The terms “piconet”, “master”, “active slave”, and “parked slave” have established definitions within the preferred Bluetooth protocol. For purposes of the present invention, those established definitions are inclusive of the established definitions of counterpart terms within other protocols that may be utilized in an implementation of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of operating a master wireless device of a first piconet in forming a second piconet:
identifying one or more master candidates for the second piconet from among a plurality of slave wireless devices within the first piconet; and
selecting a master of the second piconet from among the one or more master candidates.

2. The method of claim 1, further comprising:
assigning one or more slave candidates from among the plurality of slave wireless devices within the first piconet to the second piconet.

3. The method of claim 1, further comprising:
instructing the master of the second piconet to invite one or more of the slave wireless devices within the first piconet to enlist in the second piconet.

4. A method of operating a master wireless device of a first piconet in forming a second piconet:
receiving a first operational data indicative of each operational link between a base site and a first set of two or more slave wireless devices within the first piconet;
receiving a second operational data indicative of each operational link between the first set of two or more slave wireless devices and a second set of one or more slave wireless devices; and
selecting a master of the second piconet from among the first set of two or more slave wireless devices based upon the first operational data and the second operational data.

5. The method of claim 4, further comprising:
assigning one or more slave candidates from among the plurality of slave wireless devices within the first piconet to the second piconet.

6. The method of claim 4, further comprising:
instructing the master of the second piconet to invite one or more of the slave wireless devices within the first piconet to enlist in the second piconet.

7. A method of operating a master wireless device of a first piconet in forming a second piconet:
selecting a master of the second piconet from among a plurality of slave wireless devices within the first piconet; and
assigning one or more of the slave wireless devices within the first piconet to enlist into the second piconet.

8. A method of operating a master wireless device of a first piconet in forming a second piconet:
selecting a first master of the second piconet from among a plurality of slave wireless devices within the first piconet; and
selecting a second master of the second piconet from among a plurality of slave wireless devices within the first piconet in response to a communication from the first master of the second piconet that is indicative of a failure of the first master of the second piconet to enlist one or more slave wireless devices to the second piconet.

9. A system, comprising:
a master wireless device of a first piconet; and
a plurality of slave wireless device of the first piconet,
wherein said master wireless device operable to identify one or more master candidates for the second piconet from among a plurality of slave wireless devices within the first piconet, and
wherein said master wireless device is further operable to select a master of the second piconet from among the one or more master candidates.

10. The system of claim 9, wherein said master wireless device is further operable to assign one or more slave candidates from among the plurality of slave wireless devices within the first piconet to the second piconet.

11. The system of claim 9, wherein said master wireless device is further operable to instruct the master of the second piconet to invite one or more of the slave wireless devices within the first piconet to enlist in the second piconet.

12. A system, comprising:
a master wireless device of a first piconet; and
a plurality of slave wireless device of the first piconet,
wherein said master wireless device operable to receive a first operational data indicative of each operational link between a base site and a first set of two or more slave wireless devices within the first piconet,
wherein said master wireless device is further operable to receive a second operational data indicative of each operational link between the first set of two or more slave wireless devices and a second set of one or more slave wireless devices, and
wherein said master wireless device is further operable to select a master of the second piconet from among the first set of two or more slave wireless devices based upon the first operational data and the second operational data.

13. The system of claim 12, wherein said master wireless device is further operable to assign one or more slave candidates from among the plurality of slave wireless devices within the first piconet to the second piconet.

14. The system of claim 12, wherein said master wireless device is further operable to instruct the master of the second piconet to invite one or more of the slave wireless devices within the first piconet to enlist in the second piconet.

15. A system, comprising:
a master wireless device of a first piconet; and
a plurality of slave wireless device of the first piconet,
wherein said master wireless device operable to select a master of the second piconet from among a plurality of slave wireless devices within the first piconet, and
wherein said master wireless device is further operable to assign one or more of the slave wireless devices within the first piconet to enlist into the second piconet.

16. A system, comprising:
a master wireless device of a first piconet; and
a plurality of slave wireless device of the first piconet,
wherein said master wireless device operable to select a first master of the second piconet from among a plurality of slave wireless devices within the first piconet, and
wherein said master wireless device is further operable to select a second master of the second piconet from among a plurality of slave wireless devices within the first piconet in response to a communication from the first master of the second piconet that is indicative of a failure of the first master of the second piconet to enlist one or more slave wireless devices to the second piconet.

17. A wireless device, comprising:
a first set of one or more modules operable to identify one or more master candidates for the second piconet from among a plurality of slave wireless devices within the first piconet; and
a second set of one or more modules operable to select a master of the second piconet from among the one or more master candidates.

18. A wireless device, comprising:
a first set of one or more modules operable to receive a first operational data indicative of each operational link between a base site and a first set of two or more slave wireless devices within the first piconet;
a second set of one or more modules operable to receive a second operational data indicative of each operational link between the first set of two or more slave wireless devices and a second set of one or more slave wireless devices, and
a third set of one or more modules operable to select a master of the second piconet from among the first set of two or more slave wireless devices based upon the first operational data and the second operational data.

19. A system, comprising:
a base site; and
a plurality of wireless devices within a first ad hoc network,
wherein said plurality of wireless devices are operable to divide the first ad hoc network into a plurality of ad hoc networks forming multiple communication links to said base site.

20. A method, comprising:
establishing a communication link between a base site and a first ad hoc network; and
dividing the first ad hoc network into a plurality of ad hoc networks forming multiple communication links to the base site.
